(19) United States
(12) Patent Application Publication
(10) Pub. No.: US 2016/0009025 A1
(43) Pub. Date: Jan. 14, 2016

(54) APPARATUS AND METHOD OF MANUFACTURING DISPLAY APPARATUS

(71) Applicant: Samsung Display Co., Ltd., Yongin-city (KR)

(72) Inventors: Semi LEE, Yongin-city (KR); Katsuhiko Tanaka, Yongin-city (KR); Soochan Lee, Yongin-city (KR); Jaeyoung Kim, Yongin-city (KR); Dongjin Ok, Yongin-city (KR); Jinsuk Lee, Yongin-city (KR)

(21) Appl. No.: 14/728,692

(22) Filed: Jun. 2, 2015

(30) Foreign Application Priority Data
Jul. 8, 2014 (KR) 10-2014-0085361

(51) Int. Cl. B29C 65/78

(52) U.S. Cl. CPC B29C 65/787; B29L 2031/7232

(57) ABSTRACT

An apparatus for manufacturing a display apparatus includes: a jig configured to support a window, wherein the window is formed such that at least a portion is curved; a lamination roller configured to laminate a sheet member to the window by applying pressure, wherein the lamination roller is separated from the jig; a pressure roller configured to contact the lamination roller, wherein the pressure roller is disposed such that a rotation axis of the pressure roller and a rotation axis of the lamination roller is disposed diagonally with respect to a driving direction of the lamination roller; and a transfer member disposed between the jig and the lamination roller, wherein the transfer member is configured to transfer the sheet member.

### CROSS REFERENCE TO RELATED APPLICATION

This application claims priority from and the benefit of Korean Patent Application No. 10-2014-0085361, filed on Jul. 8, 2014, which is hereby incorporated by reference for all purposes as if fully set forth herein.

### BACKGROUND

1. Field

One or more embodiments of the present invention relate to an apparatus and a method of manufacturing a display apparatus.

2. Discussion of the Background

Portable electronic devices are being widely used. Examples of the portable electronic devices include small electronic devices such as mobile phones, and tablet PCs.

Such portable electronic devices include display panels to provide visual information, e.g., images, to users and support various functions. Recently, due to the reduced sizes of components for driving display panels, the display panels are becoming more important in electronic devices. Also, the display panels are being developed so that they may be bent at a certain angle from a flat state.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide an apparatus and a method of manufacturing a display apparatus.

Additional aspects of the invention will be set forth in part in the description which follows and, in part will be apparent from the description, or may be learned by practice of the presented embodiments.

An exemplary embodiment of the present invention discloses an apparatus for manufacturing a display apparatus including: a jig configured to support a window, wherein the window is formed such that at least a portion is curved; a lamination roller configured to laminate a sheet member to the window by applying pressure, wherein the lamination roller is separated from the jig; a pressure roller configured to contact the lamination roller, wherein the pressure roller is disposed such that a rotation axis of the pressure roller and a rotation axis of the lamination roller is disposed diagonally with respect to a driving direction of the lamination roller; and a transfer member disposed between the jig and the lamination roller, wherein the transfer member is configured to transfer the sheet member.

An exemplary embodiment of the present invention discloses a method of manufacturing a display apparatus including: attaching a sheet member to a transfer member; moving the transfer member to deliver the sheet member into a chamber, wherein a jig is disposed in the chamber and a window is placed on the jig, wherein at least a portion of a window is curved; and laminating the sheet member to the window by driving a lamination roller in at least one of a linear direction and a rotation direction in the chamber, applying pressure to the transfer member, wherein a pressure roller is configured to contact the lamination roller and rotate, such that a rotation axis of the pressure roller and a rotation axis of the lamination roller is disposed diagonally with respect to a driving direction of the lamination roller.

These general and specific embodiments may be implemented by using a system, a method, a computer program, or a combination of the system, the method, and the computer program.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a conceptual view of an apparatus for manufacturing a display apparatus according to an exemplary embodiment of the present invention.

FIG. 2 is a cross-sectional view of a lamination roller and a pressure roller of FIG. 1.

FIGS. 3A, 3B, and 3C are front views of various exemplary embodiments of the lamination roller and the pressure roller of FIG. 2.

FIGS. 4A and 4B are cross-sectional views of various exemplary embodiments of a contact prevention unit of FIG. 1.

FIG. 5 is a cross-sectional view of a display apparatus manufactured by using an apparatus for manufacturing a display apparatus according to an exemplary embodiment of the present invention.

FIG. 6 is a cross-sectional view of a display panel of FIG. 5.

### DETAILED DESCRIPTION OF THE ILLUSTRATED EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that although the terms “first”, “second”, etc. may be used herein to describe various components, these components should not be limited by these terms. These components are only used to distinguish one component from another.

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “formed on,” another layer, region, or component, it can be directly or indirectly formed on the other layer, region, or component. That is, for example, intervening layers, regions, or components may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Sizes of elements in the drawings may be exaggerated for convenience of explanation. In other words, since sizes and thicknesses of components in the drawings are arbitrarily illustrated for convenience of explanation, the following embodiments are not limited thereto.

In the following examples, the x-axis, the y-axis and the z-axis are not limited to three axes of a rectangular coordinate system, and may be interpreted in a broader sense. For example, the x-axis, the y-axis, and the z-axis may be perpendicular to one another, or may represent different directions that are not perpendicular to one another.

When a certain embodiment may be implemented differently, a specific process order may be performed differently from the described order. For example, two consecutively described processes may be performed substantially at the same time or performed in an order opposite to the described order.

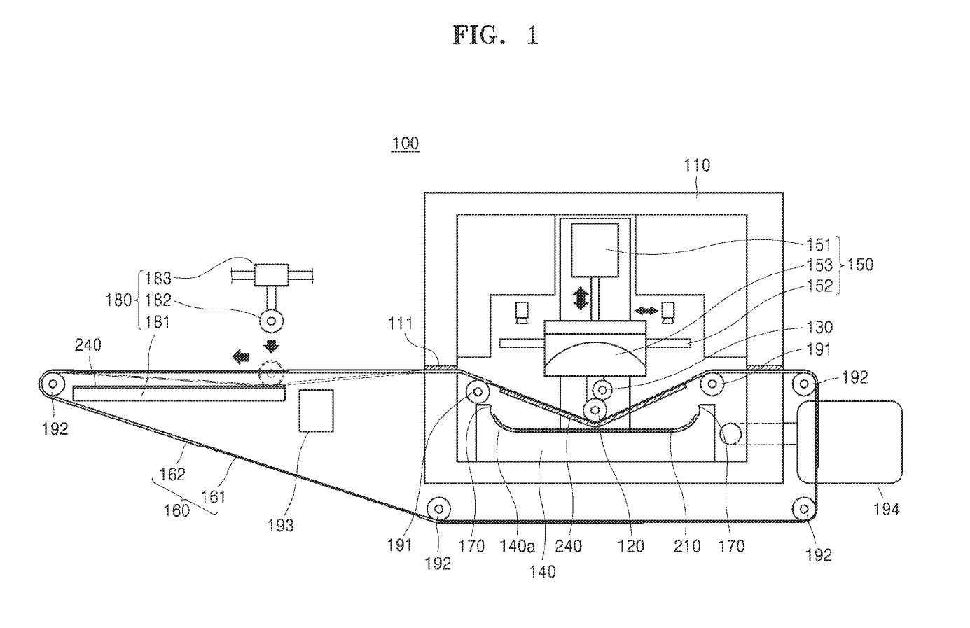

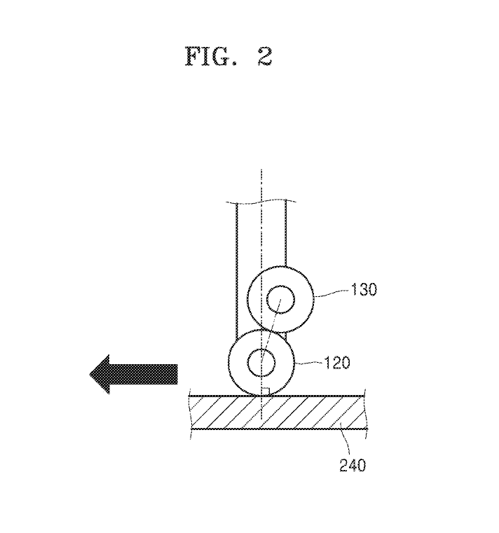

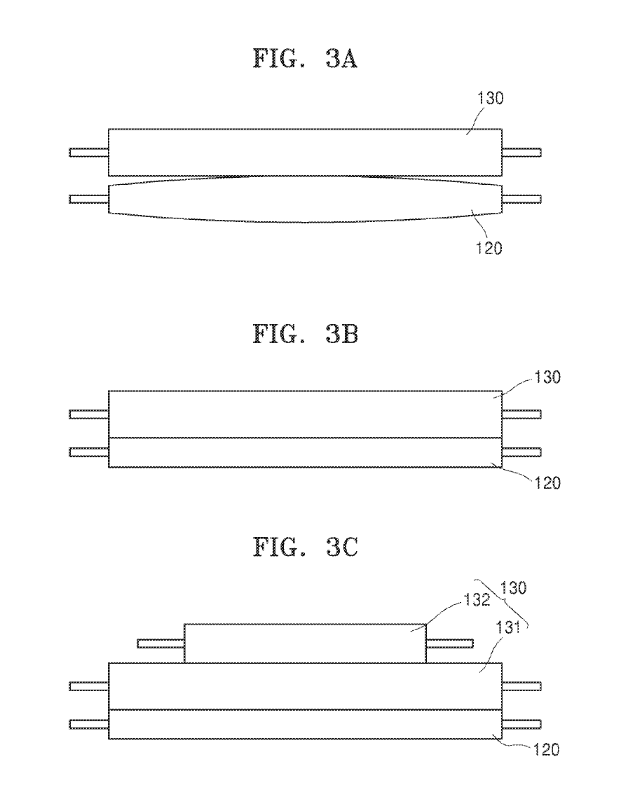

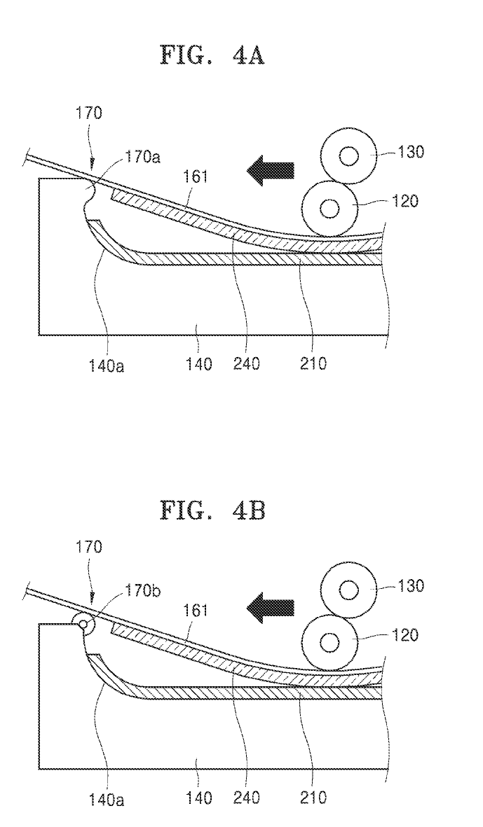

FIG. 1 is a conceptual view of an apparatus 100 for manufacturing a display apparatus, according to an exemplary embodiment of the present invention. FIG. 2 is a cross-sectional view of a lamination roller 120 and a pressure roller 130 of FIG. 1. FIGS. 3A, 3B, and 3C are front views of various exemplary embodiments of the lamination roller 120 and the pressure roller 130 of FIG. 2. FIGS. 4A and 4B are cross-sectional views of various exemplary embodiments of a contact prevention unit 170 of FIG. 1.

Referring to FIGS. 1 to 4B, an apparatus 100 for manufacturing a display apparatus may include a chamber 110, the lamination roller 120, the pressure roller 130, a jig 140, a driver 150, a transfer member 160, supporting rollers 191, a transport roller 192, the contact prevention unit 170, a sheet member attaching unit 180, a vision unit 193, and a vacuum pump 194.

An inner space is formed inside the chamber 110, and the inner space may be connected to the outside. The chamber 110 may be formed in various forms. For example, the chamber 110 may have an opening and exit, and a seal 111 may be provided at the opening and exit to seal the inside of the chamber 110 from the outside. The seal 111 may include a penetration hole through which the transfer member 160 may penetrate. A shutter may be provided at the opening and the exit to seal the inside of the chamber 110 from the outside, and the transfer member 160 may be moved to be delivered into the chamber 110 through the shutter.

The chamber 110 may be divided into a plurality of regions. The chamber 110 may include separation walls that define each region. The separation walls may each include a shutter and be opened or closed to separate or connect the plurality of regions. An outer wall of the chamber 110 may include a shutter to seal the inside of the chamber 110 from the outside or connect the inside of the chamber 110 to the outside. The outer wall of the chamber 110 may be disposed to be adjacent to the outside.

When the inside of the chamber 110 is divided into the plurality of regions as described above, the vacuum pump 194 may be provided in each region to adjust a pressure of each region in the chamber 110. More particularly, the vacuum pump 194 may independently adjust the pressure of each region in the chamber 110.

Although following detailed description provides an exemplary embodiment that includes the chamber 110 with a single space formed therein, shutters provided at the opening and the exit of the chamber 110, and a single vacuum pump 194 connected to the chamber 110, the exemplary embodiment is provided merely for the purpose of convenience of description, and therefore, the number of regions in the changer 110 according to the exemplary embodiments of the present invention is not limited thereto.

A width or a length of the lamination roller 120 may be the same as or greater than a width or length of at least one of a sheet member 240 and a window 210. The lamination roller 120 may be formed of various materials, for example, metal or ceramic, to which may reduce a deformation of the lamination roller 120 from external pressure applied thereto during lamination of the sheet member 240 and/or the window 210. The lamination roller 120 may include a central portion formed of metal or ceramic and a portion surrounding the central portion formed of a flexible material, such as rubber or silicon.

The lamination roller 120 may be formed in various shapes. For example, the lamination roller 120 may be formed in a cylinder shape, such as an ordinary roller. The central portion of the lamination roller 120 may be thicker than other portions thereof. The lamination roller 120 may be formed in a shape of a crown roller, such that a cross-section area of the lamination roller 120 perpendicular to a length direction of the lamination roller 120 may be larger or the largest in the center and gradually decrease toward both ends of the lamination roller 120.

The central portion of the lamination roller 120 may be relatively thick, and thus, a deformation of the lamination roller 120 from the lamination of the sheet member 240 to the window 210 may be reduced.

The pressure roller 130 may be formed similar to the lamination roller 120. For example, the pressure roller 130 may be formed as a cylindrical roller or a crown roller. The pressure roller 130 may be installed to be rotatable and contacting the lamination roller 120.

The pressure roller 130 as described above may be disposed to contact the central portion of the lamination roller 120, and a deformation of the pressure roller 130 may be reduced when the lamination roller 120 is operating.

More particularly, when the lamination roller 120 laminates the sheet member 240 to the window 210, the lamination roller 120 may move while pressing the sheet member 240. The lamination roller 120 may be deformed from such movement and external pressure applied by the sheet member 240. Further, both ends of the lamination roller 120 may be fixed, but the central portion of the lamination roller 120 may not be supported, such that the central portion may be free. Accordingly, the central portion may be deformed more than the both ends thereof. Therefore, the pressure roller 130 may be provided in the central portion of the lamination roller 120 to support the central portion thereof, which may reduce the deformation of the lamination roller 120.

The pressure roller 130 may be formed of one or a plurality of pressure rollers. When the pressure roller 130 is formed of only one pressure roller, the pressure roller 130 may be disposed to contact the lamination roller 120 as shown in FIGS. 3A and 3B.

When the pressure roller 130 is formed of a plurality of pressure rollers, the pressure roller 130 may be disposed to contact the lamination roller 120 as shown in FIG. 3C. The number of pressure rollers included in the pressure roller 130 is not limited to that shown in FIG. 3C.

For example, the pressure roller 130 may include a first pressure roller 131 that contacts the lamination roller 120, and a second pressure roller 132 that contacts the first pressure roller 131 and is disposed in a central portion of the first pressure roller 131. The first and second pressure rollers 131 and 132 may have different sizes. For example, the first pressure roller 131 may be larger than the second pressure roller 132. More particularly, the first and second pressure rollers 131 and 132 described above may be disposed in the central portion of the lamination roller 120 to reduce deformation of the central portion of the lamination roller 120. At least one of the first and second pressure rollers 131 and 132 may be formed in a shape of a cylindrical roller or a crown roller.

The number of pressure rollers included in the pressure roller 130 is not limited to the description above, and any number of pressure rollers may be included in the pressure roller 130 as necessary. Although following detailed description provides an exemplary embodiment of which the pressure roller 130 includes only one pressure roller, the disclosure is provided merely for the purpose of convenience of description, and therefore, the number of pressure rollers according to the exemplary embodiments of the present invention is not limited thereto.

The driver 150 may control at least one of a linear movement or a rotation movement of the lamination roller 120. The driver 150 may include a first driver 151 that drives the lamination roller 120 to perform a first linear movement in a first direction, and a second driver 152 that drives the lamination roller 120 to move in a second direction perpendicular to the first direction, and a third driver 153 that drives the lamination roller 120 to rotate.

More specifically, the first driver 151 may linearly move the lamination roller 120 and the pressure roller 130 up and down. The first driver 151 may move the lamination roller 120 and/or the pressure roller 130 up and down with respect to the jig 140. The second driver 152 may linearly move the lamination roller 120 and the pressure roller 130 in a length direction or a width direction of the jig 140. The third driver 153 may rotate the lamination roller 120 and the pressure roller 130 by a certain angle with respect to a point. The first driver 151 may include a cylinder, and the second driver 152 and the third driver 153 may include a motor and a gear unit. The first driver 151 and the third driver 153 may also include a motor and a gear unit, and the second driver 152 may include a cylinder.

Referring to FIG. 2, the lamination roller 120 and the pressure roller 130 may be disposed such that a rotation axis of the pressure roller 130 and a rotation axis of the lamination roller 120 are disposed diagonally with respect to a driving direction of the lamination roller 120. The pressure roller 130 may be disposed on an incline in a direction opposite to the driving direction of the lamination roller 120. More specifically, a line segment connecting the rotation axis of the pressure roller 130 and the rotation axis of the lamination roller 120 may form an angle of at least 5° with a line segment crossing the rotation axis of the lamination roller 120 perpendicular to a surface of the sheet member 240.

In more detail, when laminating using the pressure roller 130 and the lamination roller 120 disposed as described above, force may be applied to the lamination roller 120 in both the first direction and the second direction. More specifically, since the rotation axis of the pressure roller 130 is disposed higher than the rotation axis of the lamination roller 120, the pressure roller 130 may support the force applied to the lamination roller 120 in the first direction. Similarly, since the rotation axis of the pressure roller 130 is behind the rotation axis of the lamination roller 120 with respect to the driving direction of the lamination roller 120, the pressure roller 130 may support the force applied to the lamination roller 120 in the second direction. Accordingly, the pressure roller 130 may reduce deformation of the central portion of the lamination roller 120.

The window 210, of which at least a portion is curved, may be placed on the jig 140. A window mounting groove 140a may be formed on a surface of the jig 140 such that the curved portion of the window 210 may be placed. At least a portion of the window mounting groove 140a may be curved correspondingly to the outer side of the window 210. Although following detailed description provides an exemplary embodiment of which the window mounting groove 140a includes both ends curved inwards and a central portion formed flat, the disclosure is provided merely for the purpose of convenience of description, and therefore, the shape of the window mounting groove 140a according to the exemplary embodiments of the present invention is not limited thereto.

The jig 140 may be formed of various materials. For example, the jig 140 may be formed of a hard material, such as metal or ceramic. Alternatively, the jig 140 may be formed of a flexible material, such as rubber or silicon. Although following detailed description provides an exemplary embodiment of which the jig 140 is formed of a hard material, such as metal or ceramic, the discloses is provided merely for the purpose of convenience of description, and therefore, the material forming the jig 140 according to the exemplary embodiments of the present invention is not limited thereto.

When the jig 140 is formed by using a hard material, a cushion unit (not shown) may be provided in at least a portion of the window mounting groove 140a. The cushion unit may be formed by using at least one of flexible material, such as rubber or silicon. More particularly, the cushion unit may reduce the damage to the window 210 by partially absorbing pressure applied to the window 210 during the lamination of the sheet member 240 to the window 210. The sheet member 240 may be attached to the transfer member 160. An adhesive may be applied to the transfer member 160 to increase adhesion strength thereof. Also, the transfer member 160 may be formed with different materials according to sections. For example, the transfer member 160 may include a first transfer member 161 formed of metal and a second transfer member 162 formed of flexible materials, such as rubber or silicon. The first transfer member 161 may maintain an overall tension of the transfer member 160, and the second transfer member 162 may be flexible to change its shape and appropriately conform to an outer shape of the window 210 during the lamination of the sheet member 240 to the window 210.

The first and second transfer members 161 and 162 may be connected to each other. The first and second transfer members 161 and 162 may be alternately connected to form a closed-loop.

The transfer member 160 may be transported by the transport roller 192. The transport roller 192 may be formed of a plurality of transport rollers, and the plurality of transport rollers may be spaced apart to maintain the tension of the transfer member 160. In addition, the transport roller 192 may transport the transfer member 160 in a closed-loop shape and continuously supply the second transfer member 162 to the sheet member attaching unit 180.

The supporting roller 191 may be disposed in the chamber 110. More specifically, the supporting roller 191 may be provided at both ends of the jig 140. Referring to FIG. 1, the supporting roller 191 may be provided at a position lower than that of the transfer member 160, which may be supported by the transport roller 192 disposed outside respective sides of the chamber 110. Therefore, when the lamination roller 120 descends, the supporting roller 191 may contact the transfer member 160 and support the transfer member 160. When the lamination roller 120 is pressing the second transfer member 162, the supporting roller 191 may maintain the tension in the second transfer member 162 and regulate, impede or prevent the second transfer member 162 from touching the both ends of the jig 140.

The contact prevention unit 170 may be provided at least one of the both ends of the jig 140. The contact prevention unit 170 may be protruded toward the inside of the window mounting groove 140a. More specifically, the contact prevention unit 170 may be formed at ends of the window mounting groove 140a that is formed at the both ends of the jig 140. Referring to FIG. 4A, the contact prevention unit 170 may include a contact prevention protrusion 170a that protrudes from the jig 140 toward the inside of the window mounting groove 140a. Referring to FIG. 4B, the contact prevention unit 170 may include a contact prevention roller 170b that protrudes from the jig 140 toward the inside of the window mounting groove 140a. Although following detailed description provides an exemplary embodiment of which the contact prevention unit 170 includes the contact prevention roller 170b, the disclosure is provided merely for the purpose of convenience of description, and therefore, the structure of contact prevention unit 170 according to the exemplary embodiments of the present invention is not limited thereto.

The contact prevention unit 170 may regulate, impede or prevent the sheet member 240 from being attached to or contacting an end of the window 210 before other portions of the window 210 and the sheet member 240 are laminated.

The sheet member attaching unit 180 may attach the sheet member 240 onto the transfer member 160. The sheet member attaching unit 180 may include a chuck table 181, and an attachment roller 182 that is separate from the chuck table 181. The sheet member 240 is placed on the chuck table 181, and the attachment roller 182 is configured to attach the sheet member 240 to the transfer member 160 by applying pressure.

The attachment roller 182 may move in at least one of the first and second directions. The sheet member attaching unit 180 may include an attachment roller driver 183 that drives the attachment roller 182 to move in at least one of the first and second directions. The attachment roller driver 183 is the same as or similar to the first and second drivers 151 and 152, and thus detailed description thereof will be omitted.

The vision unit 193 is disposed between the sheet member attaching unit 180 and the chamber 110, and is configured to capture an image showing whether the sheet member 240 is properly attached to the transfer member 160. Also, the vision unit 193 may be further configured to capture an image of the second transfer member 162. The vision unit 193 may include at least one of a general camera and a charge-coupled device (CCD) camera.

The image captured by the vision unit 193 may be transferred to a controller (not shown) that is separately included, and the controller may compare the captured image to a preset image and determine whether the sheet member 240 is properly attached to the transfer member 160. In response to the determination, the controller may adjust the chuck table 181 to align its position and/or stop operations of the apparatus 100.

A method of manufacturing the display apparatus by using the apparatus 100 will be described below. First, the sheet member 240 and the window 210 are manufactured. The sheet member 240 may be formed in various ways. For example, the sheet member 240 may include at least one of a protection film, an optically clear adhesive (OCA) film, a touch screen panel (TSP), and a display panel. However, the sheet member 240 is not limited thereto, and may include any flexible sheet type member that may be attached to the window 210 when manufacturing the display apparatus.

The display panel may include, but not limited to, a liquid display panel (LCD), a plasma display panel, and an organic light-emitting display panel. The display panel may be flexible, and a shape thereof may be bent to a certain degree.

Although following detailed description provides an exemplary embodiment of which the sheet member 240 is an OCA film, the disclosure is provided merely for the purpose of convenience of description, and therefore, the structure of the sheet member 240 according to the exemplary embodiments of the present invention is not limited thereto.

When the sheet member 240 is prepared, the sheet member 240 is placed on the chuck table 181 and the transport roller 192 may transport the transfer member 160 such that the second transfer member 162 is disposed over the sheet member 240. Whether the second transfer member 162 is precisely disposed on the sheet member 240 may be determined via the vision unit 193.

Then, the attachment roller driver 183 may lower the attachment roller 182 and drive the attachment roller 182 in at least one of a width direction and a length direction of the sheet member 240, thereby attaching the sheet member 240 to the second transfer member 162. As described above, an adhesive may be applied on the sheet member 240 so that the second transfer member 162 may be attached thereon.

After the above-described process, the transport roller 192 may be operated to transport the transfer member 160. The second transfer member 162 may be moved to be delivered into the chamber 110. The shutter provided at the opening of the chamber 110 may be opened.

When the sheet member 240 is delivered into the chamber 110, the sheet member 240 may be properly aligned by capturing an image by using the vision unit 193 and comparing the captured image with a preset image.

While the above-described process is being performed, the window 210 may be delivered into the chamber 110, and be placed in the window mounting groove 140a of the jig 140. As described above, the window mounting groove 140a may be formed to correspond to an outer surface of the window 210. For example, when at least a portion of the window 210 is curved, a portion of the window mounting groove 140a, on which the curved portion of the window 210 is placed, may be curved.

When the window 210 is placed on the jig 140, the first driver 151 may lower the lamination roller 120, and the second and third drivers 152 and 153 may drive the lamination roller 120 so that the lamination roller 120 performs at least one of a rotation movement and a linear movement.

When the driver 150 is operated as described above, the lamination roller 120 may move in the first direction and/or second direction and attach the sheet member 240 to the window 210. The second transfer member 162 may be formed by using a flexible material, and the sheet member 240, which may be attached to the second transportation member 162, may be laminated or attached to the window 210 by being pressed by the lamination roller 120.

When the driver 150 is being operated as described above, the lamination roller 120 may move from an end of the jig 140 to the other end of the jig 140 and thereby attach the sheet member 240 to the window 210 from the end of the jig 140 to the other end of the jig 140. As the sheet member 240 is attached to the window 210, the sheet member 240 may be separated from the second transfer member 162. The adhesion strength between the second transfer member 162 and the sheet member 240 may be configured to be smaller than an adhesion strength between the sheet member 240 and the window 210.

When the lamination roller 120 is moving as described above, the pressure roller 130 may apply pressure to the lamination roller 120. As described above, the pressure roller 130 may reduce a deformation of the lamination roller 120.

When the sheet member 240 is attached to the window 210 as described above, gas between the sheet member 240 and the window 210 may be emitted toward the inside of the chamber 110. A gas pressure inside the chamber 110 may be reduced to a vacuum state or a state similar to a vacuum state to regulate, impede or prevent the gas from being trapped between the sheet member 240 and the window 210 during the lamination of the sheet member 240 to the window 210.

During attaching the sheet member 240 to the window 210 as described above, the sheet member 240 may be attached to the window 210 on at least a portion of the window mounting groove 140a when the lamination roller 120 is close to an end of the window mounting groove 140a.

The contact prevention unit 170 may regulate, impede or prevent the second transfer member 162 from contacting the window mounting groove 140a and an end of the window 210. As a result, an end of the sheet member 240 attached to the second transfer member 162 may be spaced apart or regulated not to contact an end of the window 210. Accordingly, the end of the sheet member 240 and the end of the window 210 may not be attached to or contact each other before the lamination roller 120 laminates or attaches the end of the sheet member 240 onto the second transfer member 162.

Therefore, by using the apparatus 100 and the method of manufacturing the display apparatus, the deformation of the lamination roller 120 may be prevented or decreased when laminating the sheet member 240 to the window 210, and the lamination roller 120 may apply pressure uniformly to the sheet member 240 so that the sheet member 240 is precisely and firmly laminated to the window 210.

In addition, by using the apparatus 100 and the method of manufacturing the display apparatus, during the lamination of the sheet member 240 to the window 210 the lamination roller 120 attaches the sheet member 240 to the window 210 in a way that gas is not enclosed between the sheet member 240 and the window 210. Thus, productivity may be increased and faults may be reduced.

Furthermore, by using the apparatus 100 and the method of manufacturing the display apparatus, the contact prevention unit 170 may regulate, impede or prevent the sheet member 240 from first being attached onto an end of the window 210 first, and thus, reliability of manufactured products may be increased.

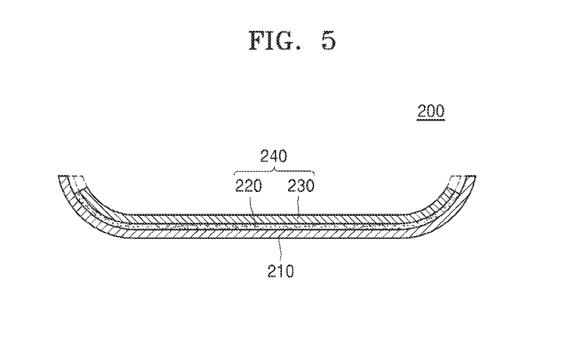

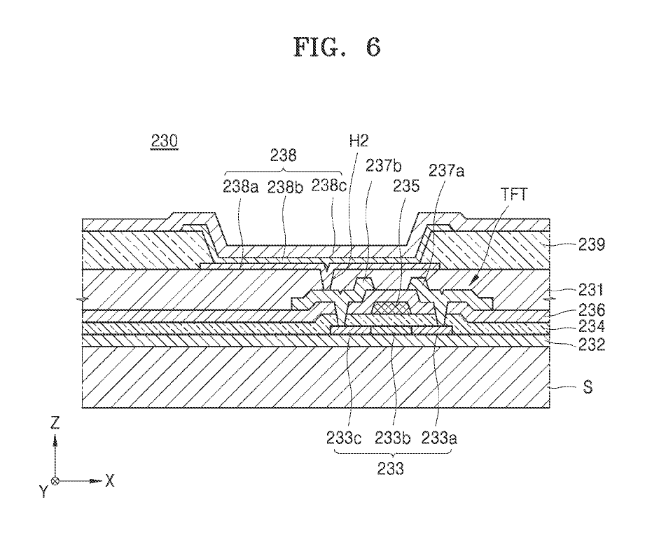

FIG. 5 is a cross-sectional view of a display apparatus 200 manufactured by using the apparatus 100 of FIG. 1. FIG. 6 is a cross-sectional view of a display panel 230 of FIG. 5.

Referring to FIGS. 5 and 6, the display apparatus 200 may include a window 210 and a sheet member 240. Portions of the window 210 may be curved. In more detail, the window 210 may have a flat surface, and at least one end of the flat surface may be curved. More particularly, both ends of the flat surface may be curved.

As described above, the sheet member 240 may include at least one of an OCA film, the display panel 230, a black matrix film (not shown), a release paper, a protection film, and a TSP (not shown). Although following detailed description provides an exemplary embodiment of which the sheet member 240 only includes the display panel 230 and an adhesive layer 220, the disclosure is provided merely for the purpose of convenience of description, and therefore, the structure of the sheet member 240 according to the exemplary embodiments of the present invention is not limited thereto.

Since the adhesive layer 220 may be a general material for attaching the window 210 and the display panel 230, detailed description of the adhesive layer 220 will be omitted.

The display panel 230 may be flexible. Also, a size of the display panel 230 may be different from a size of the window 210. More particularly, the size of the display panel 230 may be smaller than the size of the window 210. The display panel 230 may be formed in various ways as described above. An exemplary embodiment in which the display panel 230 is an organic light-emitting display panel will be described in more detail.

The display panel 230 may include a first substrate S and an emission unit (not shown). The display panel 230 may further include a thin film encapsulation layer (not shown) formed on the emission unit. The thin film encapsulation layer (not shown) may be in the form of a thin film. Also, when the thin film encapsulation layer (not shown) is in the form of a thin film, a second substrate (not shown) may be further included. Although following detailed description provides an exemplary embodiment of which the thin film encapsulation layer (not shown) is a thin film, the disclosure is provided merely for the purpose of convenience of description, and therefore, the structure of the thin film encapsulation layer (not shown) according to the exemplary embodiments of the present invention is not limited thereto.

The emission unit may be formed on the first substrate S. The emission unit may include a thin film transistor (TFT) TFT, and a passivation layer 231 may be formed to cover the emission unit and the TFT TFT. An organic light-emitting diode (OLED) 238 may be formed on the passivation layer 231.

The first substrate S may be formed of glass, but is not limited thereto, and may be formed of plastic or metal, such as stainless steel (SUS) or titanium (Ti). The first substrate S may also be formed of polyimide (PI). Although following detailed description provides an exemplary embodiment of which the first substrate S is formed of PI, the disclosure is provided merely for the purpose of convenience of description, and therefore, the structure of the first substrate S according to the exemplary embodiments of the present invention is not limited thereto.

A buffer layer 232, formed of an organic compound and/or an inorganic compound, is additionally formed on the first substrate S. The buffer layer 232 may be formed of SiOₓ(x≧1) or SiNₓ(x≧1).

An active layer 233 having a predetermined pattern is formed on the buffer layer 232, and then, the active layer 233 is covered by a gate insulating layer 234. The active layer 233 includes a source area 233a, a drain area 233c, and a channel area 233b disposed between the source and drain areas 233a and 233c.

The active layer 233 may be formed to include various materials. For example, the active layer 233 may include an inorganic semiconductor material such as amorphous silicon or crystalline silicon. The active layer 233 may include an oxide semiconductor material. The active layer 233 may also include an organic semiconductor material. Although following detailed description provides an exemplary embodiment of which the active layer 233 is formed of amorphous silicon, the disclosure is provided merely for the purpose of convenience of description, and therefore, the composition of the active layer 233 according to the exemplary embodiments of the present invention is not limited thereto.

The active layer 233 may be formed by forming an amorphous silicon layer on the buffer layer 232, crystallizing the amorphous silicon layer to form a polycrystalline silicon layer, and patterning the polycrystalline silicon layer. In the active layer 233, the source and drain areas 233a and 233c are doped with impurities according to a type of TFTs, e.g., whether the TFT is a driving TFT (not shown) or a switching TFT (not shown).

On an upper surface of the gate insulating layer 234, a gate electrode 235 may be formed corresponding to the active layer 233, and an interlayer insulating layer 236 may be formed covering the gate electrode 235.

A contact hole is formed in the interlayer insulating layer 236 and the gate insulating layer 234 exposing a part of the source area 233a and a part of the drain area 233c. A source electrode 237a and a drain electrode 237b are formed on the interlayer insulating layer 236 respectively contacting the exposed part of the source area 233a and the exposed part of the drain area 233c.

The passivation layer 231 is formed on the above-described TFT TFT, and a pixel electrode 238a of the OLED 238 is formed on the passivation layer 231. The pixel electrode 238a contacts the drain electrode 237b of the TFT TFT through a via hole H2 formed in the passivation layer 231. The passivation layer 231 may be formed as a single layer or multiple of layers including at least one of an inorganic material and an organic material. The passivation layer 231 may be formed as a planarization layer such that an upper surface thereof is flat regardless of curves in a lower layer thereof. The passivation layer 231 may also be curved correspondingly to the curves in the lower layer thereof. Also, the passivation layer 231 may be formed of a transparent insulating material to obtain a resonance effect.

After the pixel electrode 238a is formed on the passivation layer 231, a pixel defining layer 239 is formed by using at least one of an organic material and/or an inorganic material to cover the pixel electrode 238a and the passivation layer 231. The pixel defining layer 239 may include an opening exposing the pixel electrode 238a.

An intermediate layer 238b and an opposite electrode 238c are formed on the pixel electrode 238a.

The intermediate layer 238b includes an organic emission layer (organic EML). The intermediate layer 238b includes an organic EML, and may further include at least one selected from of a hole injection layer (HIL), a hole transport layer (HTL), an electron transport layer (ETL), and an electron injection layer (EIL). However, the present exemplary embodiment is not limited thereto, and the intermediate layer 238b may include the organic EML and other various functional layers.

The pixel electrode 238a may function as an anode electrode, and the opposite electrode 238c may function as a cathode electrode, or vice versa. The pixel electrode 238a and the opposite electrode 238c are insulated from each other by the intermediate layer 238b. Voltages of different polarities are applied via the intermediate layer 238b so that the organic EML included in the intermediate layer 238b may emit a light.

A unit pixel includes a plurality of sub-pixels that may emit various colors of light. For example, the plurality of sub-pixels may include sub-pixels that emit red, green, and blue light, or sub-pixels that emit red, green, blue, and white light.

The plurality of sub-pixels may include the intermediate layer 238b having organic EMLs that emit various colors of light. For example, the plurality of sub-pixels include the intermediate layer 238b having organic EMLs that emit red, green, and blue light.

As another example, the plurality of sub-pixels that emit various colors of light may include the intermediate layer 238b that includes organic EMLs that emit the same light, e.g., white, and may include a color converting layer or a color filter that converts white light into a predetermined colored light.

The intermediate layer 238b emitting white light may have various structures, e.g., a structure in which at least a light-emitting substance emitting red light, a light-emitting substance emitting green light, and a light-emitting substance emitting blue light are stacked on one another.

As another example for emitting white light, the intermediate layer 238b may include a structure in which at least a light-emitting substance emitting red light, a light-emitting substance emitting green light, and a light-emitting substance emitting blue light are mixed.

The colors, red, green, and blue, are only provided as examples, and the present exemplary embodiments are not limited thereto. In other words, any combination of various colors, as long as the combination of the colors is capable of emitting white light, may be employed in addition to a combination of red, green and blue.

The thin film encapsulation layer (not shown) may include a plurality of inorganic layers, or an inorganic layer and an organic layer.

The organic layer of the thin film encapsulation layer (not shown) is formed of polymer, and may be a single layer or a stack of layers formed of any one of polyethylene terephthalate, PI, polycarbonate, epoxy, polyethylene, and polyacrylate. The organic layer may be formed of polyacrylate, more specifically, a polymerized monomer composition including a diacrylate-based monomer and a triacrylate-based monomer. The monomer composition may further include a monoacrylate-based monomer. Also, the monomer composition may further include any well-known photo initiator such as trimethyl benzoyl diphenyl phosphine oxide (TPO), but aspects of the invention are not limited thereto.

The inorganic layer of the thin film encapsulation layer (not shown) may be a single layer or a stack of layers including metal oxide or metal nitride. In more detail, the inorganic layer may include any one of SiN_{X}, Al₂O₃, SiO₂, and TiO₂.

The top layer of the thin film encapsulation layer (not shown) that is exposed to the outside may be formed of an inorganic layer in order to reduce or prevent an intrusion of moisture into the OLED 238.

The thin film encapsulation layer (not shown) may include at least one sandwich structure in which at least one organic layer is inserted between at least two inorganic layers. The thin film encapsulation layer (not shown) may include at least one sandwich structure in which at least one inorganic layer is inserted between at least two organic layers. The thin film encapsulation layer (not shown) may also include both of the sandwich structure in which at least one organic layer is inserted between at least two inorganic layers and the sandwich structure in which at least one inorganic layer is inserted between at least two organic layers.

The thin film encapsulation layer (not shown) may include a first inorganic layer, a first organic layer, and a second inorganic layer sequentially formed from the top of the OLED 238.

According to an exemplary embodiment, the thin film encapsulation layer (not shown) may include a first inorganic layer, a first organic layer, a second inorganic layer, a second organic layer, and a third inorganic layer sequentially formed from the upper portion of the OLED 238.

According to an exemplary embodiment, the thin film encapsulation layer (not shown) may include a first inorganic layer, a first organic layer, a second inorganic layer, a second organic layer, a third inorganic layer, a third organic layer, and a fourth inorganic layer sequentially formed from the upper portion of the OLED 238.

A halogenated metal layer including lithium fluoride (LiF) may be additionally included between the OLED 238 and the first inorganic layer. The halogenated metal layer may reduce the damage to the OLED 238 during the formation of the first inorganic layer by a sputtering method or a plasma deposition method.

The first organic layer may be thinner than the second inorganic layer, and the second organic layer may be thinner than the third inorganic layer

The display panel 230 may be disposed on the chuck table 181, attached to the transfer member 160, delivered into the chamber 110, and then, laminated to the window 210, in the apparatus 100 described in FIGS. 1 to 4.

Since the lamination method is the same as or similar to the description above, detailed description thereof will be omitted.

As described above, according to the one or more of the above exemplary embodiments of the present invention, an apparatus and method of manufacturing a display apparatus may precisely and quickly laminate a curved element.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. An apparatus for manufacturing a display apparatus, comprising:
a jig configured to support a window, wherein the window is formed such that at least a portion is curved;
a lamination roller configured to laminate a sheet member to the window by applying pressure, wherein the lamination roller is separated from the jig;
a pressure roller configured to contact the lamination roller, wherein the pressure roller is disposed such that a rotation axis of the pressure roller and a rotation axis of the lamination roller is disposed diagonally with respect to a driving direction of the lamination roller; and
a transfer member disposed between the jig and the lamination roller, wherein the transfer member is configured to transfer the sheet member.

2. The apparatus of claim 1, wherein at least one of the lamination roller and the pressure roller is formed such that a central portion is thicker than other portions thereof.

3. The apparatus of claim 1, wherein the pressure roller comprises:
a first pressure roller configured to contact the lamination roller; and
a second pressure roller configured to contact the first pressure roller,
wherein the second pressure roller is disposed on a central portion of the first pressure roller.

4. The apparatus of claim 1, further comprising a supporting roller disposed at both ends of the jig, wherein the supporting roller is configured to support the transfer member.

5. The apparatus of claim 1, wherein the lamination roller is formed of at least one of a metallic material and a ceramic material.

6. The apparatus of claim 1, further comprising a contact prevention unit disposed on at least one of both ends of the jig, wherein the contact prevention unit is configured to regulate the transfer member from contacting the jig and the window.

7. The apparatus of claim 6, wherein the contact prevention unit comprises a contact prevention roller.

8. The apparatus of claim 6, wherein the contact prevention unit comprises a contact prevention protrusion.

9. The apparatus of claim 1, further comprising a sheet member attaching unit configured to attach the sheet member to the transfer member.

10. The apparatus of claim 9, wherein the sheet member attaching unit comprises:
a chuck table on which the sheet member is disposed; and
an attachment roller configured to attach the sheet member to the transfer member by applying pressure.

11. The apparatus of claim 1, wherein the transfer member comprises:
a first transfer member formed of metal; and
a second transfer member formed of a flexible material,
wherein the second transfer member is connected to the first transfer member, and
wherein the second transfer member is configured to be attached to the sheet member.

12. The apparatus of claim 1, further comprising a driver, to which the lamination roller and the pressure roller are connected,
wherein the driver is configured to drive the lamination roller and the pressure roller in at least one of a rotation direction and a linear direction.

13. The apparatus of claim 1, further comprising a chamber,
wherein the chamber is configured to selectively form a vacuum state, and
wherein the jig, the lamination roller, the pressure roller, and a portion of the transfer member are disposed in the chamber.

14. The apparatus of claim 1, the pressure roller is disposed inclined in a direction opposite to the driving direction of the lamination roller.

15. A method of manufacturing a display apparatus, comprising:
attaching a sheet member to a transfer member;
moving the transfer member to deliver the sheet member into a chamber, wherein a jig is disposed in the chamber and a window is disposed on the jig, wherein at least a portion of a window is curved; and
laminating the sheet member to the window by driving a lamination roller in at least one of a linear direction and a rotation direction in the chamber, applying pressure to the transfer member,
wherein a pressure roller is configured to contact the lamination roller and rotate, such that a rotation axis of the pressure roller and a rotation axis of the lamination roller is disposed diagonally with respect to a driving direction of the lamination roller.

16. The method of claim 15, wherein the laminating of the sheet member to the window is performed while the chamber is in a vacuum state.

17. The method of claim 15, wherein the transfer member comprises:
a first transfer member formed of metal; and
a second transfer member formed of a flexible material,
wherein the second transfer member is connected to the first transfer member, and
wherein the second transfer member is configured to be attached to the sheet member before delivering the sheet member.

18. The method of claim 15, wherein at least one of the lamination roller and the pressure roller is formed such that a central portion is thicker than other portions thereof.

19. The method of claim 15, wherein a contact prevention unit is disposed at the at least one of both ends of the jig, wherein the contact prevention is configured to regulate the transfer member from contacting the jig and the window.

20. The method of claim 15, wherein the pressure roller is disposed inclined in a direction opposite to the driving direction of the lamination roller.
